(19) United States
(12) Patent Application Publication
(10) Pub. No.: US 2015/0079312 A1
(43) Pub. Date: Mar. 19, 2015

(54) THERMAL INSULATION BODY AND METHOD FOR THE PRODUCTION THEREOF

(71) Applicant: SGL CARBON SE, WIESBADEN (DE)

(72) Inventors: BODO BENITSCH, BUTTENWIESEN (DE); SINISA MILOVUKOVIC, BIBERBACH (DE); ROBERT HAUSER, AYSTETTEN (DE)

(21) Appl. No.: 14/551,300

(22) Filed: Nov. 24, 2014

Related U.S. Application Data
(63) Continuation of application No. PCT/EP2013/060567, filed on May 23, 2013.

(30) Foreign Application Priority Data
May 23, 2012 (DE) 102012208596.3

(51) Int. Cl. F16L 59/02; B32B 7/08; B32B 1/08

(52) U.S. Cl. CPC F16L 59/028; B32B 1/08; B32B 7/08; B32B 2250/05; B32B 2250/20; B32B 2262/106; B32B 2307/304; B32B 2313/04; B32B 2597/00
USPC 428/33; 428/57; 428/34.1; 29/428

(57) ABSTRACT

A thermal insulation body made of a material having carbonized fibers and/or graphitized fibers is particularly suited for lining a high-temperature furnace. The thermal insulation body is assembled from at least two component parts, wherein at least two assembled component parts each have at least one connection element and the connection elements of the at least two assembled component parts interengage positively to form an undercut.

### CROSS-REFERENCE TO RELATED APPLICATION

This application is a continuation, under 35 U.S.C. §120, of copending international application No. PCT/EP2013/060567, filed May 23, 2013, which designated the United States; this application also claims the priority, under 35 U.S.C. §119, of German patent application No. DE 10 2012 208 596.3, filed May 23, 2012; the prior applications are herewith incorporated by reference in their entirety.

### BACKGROUND OF THE INVENTION

### Field of the Invention

The present invention relates to a thermal insulation body made of a material, such as in particular hard felt, comprising carbonized fibers and/or graphitized fibers, in particular for lining a high-temperature furnace, the thermal insulation body being assembled from at least two component parts.

High-temperature processes taking place at, say, over 800° C. in an inert atmosphere place high thermal and mechanical requirements on the insulating materials used. Carbonized and optionally graphitized felts are often the material used for insulating bodies, which for example line an interior of a high-temperature furnace and thereby separate the heating chamber from the cooled external wall. Compared with the production of a thermal insulation body in one piece, for example by winding unhardened, resin-impregnated felt layers onto a mandrel and then hardening the felt material, the production of a thermal insulation body from a plurality of component parts offers the advantage of lower scrap raw material and a more efficient subsequent high-temperature treatment of the felt material.

Commonly assigned U.S. published patent application US 2007/0259185 A1 and its counterpart European patent EP 1 852 252 B1 describe a method for producing insulating bodies able to withstand high temperatures, in which, inter alia, a plurality of curved segments made of a material based on a graphite expandate compressed to a thickness of between 0.02 and 0.3 g/cm3 are fitted together to form a hollow cylindrical component. The cohesion of the individual segments is ensured by a carbonized binder containing planar anisotropic graphite particles. Furthermore, a graphite film is arranged on the internal surface of the hollow cylindrical insulating body.

U.S. Pat. No. 8,525,103 B2 and its counterpart international PCT publication WO 2011/106580 A2 describe an insulating body for a reactor, produced from a carbon-fiber material and composed of a plurality of individual plate-like components. The individual components can be coupled by “tongue-and-groove” tuck-in connections using further connection elements.

However, one problem with the known thermal insulation bodies composed of a plurality of component parts is that it is impossible to maintain the mechanical and thermal properties of the component at the transitions between contiguous component parts, i.e., at the joining surfaces. This is even the case when the component parts are glued together or mate. There is therefore the risk of heat conduction losses occurring via the transitions and of weakened mechanical stability, which is fundamentally undesirable. To prevent such heat conduction losses and maintain mechanical stability, additional elements made of graphite, carbon-fiber-based composite materials or metal can be provided at the joining surfaces. However, this leads to material build-up and/or to an accumulation of different materials, which is associated with high complexity and accordingly with higher production and storage costs. Moreover, owing to the structural separation of mechanical stability and thermal resistance, the material properties of the component parts are not locally exploited in an optimum manner.

### SUMMARY OF THE INVENTION

It is accordingly an object of the invention to provide a thermal insulation body and a method for its production which overcome the above-mentioned and other disadvantages of the heretofore-known devices and methods of this general type and which provide for a thermal insulation body that can be produced simply and cost-effectively from a plurality of component parts and which also has a reliable insulating effect and sufficiently high mechanical stability in the transition regions between the several component parts.

With the foregoing and other objects in view there is provided, in accordance with the invention, a thermal insulation body, in particular for lining a high-temperature furnace, comprising:

an assembly of at least two component parts made of a material having carbonized fibers and/or graphitized fibers;

at least two assembled component parts each having at least one connection element and the connection elements of the at least two assembled component parts engaging one another with a form-fitting connection forming an undercut.

In other words, the novel thermal insulation body is made of a material comprising carbonized fibers and/or graphitized fibers, in particular for lining a high-temperature furnace. The thermal insulation body is assembled from at least two component parts, wherein at least two assembled component parts each have at least one connection element and the connection elements of the at least two assembled component parts engage in an at least form-fitting manner, or even engage in a form-fitting and force-locking manner, to form an undercut.

The term form-fitting, as used herein, is synonymous with the terms positive fit and form-lock or form-locking connection. The term force-locking is synonymous with friction locking or friction fitting.

According to the invention, at least one connection element is provided in each case on at least two assembled component parts; that is to say, connection elements are provided on at least individual portions of the joining surfaces at which the component parts are assembled and these connection elements engage in an at least form-fitting manner to form an undercut. Owing to the undercut, the component parts are securely held together at the contacting joining surfaces—preferably in five of the six mutually orthogonal spatial directions—and can no longer be separated even under the operating conditions in a high-temperature furnace. This eliminates the need for complex adhesion of the component parts. Movement in the sixth spatial direction is preferably restricted by means of a force-locking connection. This also means that additional reinforcing elements, such as steel bands, can be dispensed with, thereby significantly cutting production and storage costs. A further particular advantage of the invention is that the undercut forms a barrier against heat conduction losses at the joining surfaces, which also means that additional insulating components for covering the joins can be spared. Since there is no build-up of different materials, discontinuities in the important material properties, such as heat conductivity, thickness, compressive strength or bending strength can additionally be reliably avoided. The invention therefore allows for a thermal insulation body that is simple to produce, self-supporting and homogenous as regards the important material parameters, and which, since it is constructed from component parts, can easily be adapted to different application specifications, for example to different furnace geometries.

The component parts are preferably held together in an at least form-fitting manner at the contacting joining surfaces in five of the six mutually orthogonal spatial directions. Movement in the sixth spatial direction is preferably restricted by a purely force-locking connection.

To achieve particularly high stability of the thermal insulation body, it is preferred for all component parts from which the thermal insulation body is assembled to each have at least one connection element, the connection elements of at least two assembled component parts engaging in each case to form an undercut.

The component parts are preferably assembled exclusively using the connection elements; that is to say, no adhesives, cramps or the like are used. This avoids foreign materials in the thermal insulation body, which can lead to undesirable discontinuities in the material properties and to heat conduction losses.

The connection elements of the at least two assembled component parts also preferably engage in a force-locking manner to form a press fit. The press fit produces a force-locking connection in addition to the form-fitting connection and this further increases the stability of the connection with respect to accidental separation. Combining a form-fitting and force-locking connection in this way produces a joint that ensures reliable and durable cohesion of the relevant component parts, even under high thermal and mechanical stress.

The connection elements of the at least two assembled component parts are, according to a preferred embodiment of the invention, formed directly onto the component parts of the thermal insulation body. In other words, the connection elements each form an integral component of the relevant component parts of the thermal insulation body. This eliminates the need for the costly attachment of additional components. Moreover, the strength of the joint is particularly high if the component parts are integrally bonded to the associated connection elements.

According to a particularly preferred embodiment of the present invention, at least one of the component parts and preferably all component parts, including the connection elements, is/are produced from a homogenous felt composed of carbonized fibers and/or graphitized fibers. Felts of this type have high temperature resistance and at the same time high mechanical strength, making them a particularly suitable material for thermal insulation in high-temperature environments.

Furthermore, it is preferred for at least one of the component parts and preferably all component parts, including the connection elements, to be produced from the same material, which is preferably a soft felt, particularly an impregnated one, composed of carbonized fibers and/or graphitized fibers, or a hard felt composed of carbonized fibers and/or graphitized fibers. This prevents undesirable discontinuities in heat conductivity or strength as well as undesirable heat loss via the contact points between two assembled component parts.

According to another preferred embodiment of the present invention, at least one of the component parts and preferably all component parts is/are produced from felt having a thickness of between 0.01 and 0.50 g/cm³, preferably between 0.10 and 0.25 g/cm³, and more preferably between 0.13 and 0.20 g/cm³. Felts having such properties have proven to be particularly well suited to the production of thermal insulation bodies of the type described above.

According to yet another preferred embodiment of the present invention, at least one of the component parts and preferably all component parts is/are produced from felt having a thickness of between 5 and 500 mm, preferably between 20 and 250 mm, and more preferably between 40 and 120 mm. Felts having such properties have proven to be particularly well suited to the production of thermal insulation bodies of the type described above.

Furthermore, particularly good results in terms of stability and insulating effect are achieved if at least one of the component parts and preferably all component parts is/are produced from felt composed of carbonized fibers and/or graphitized fibers having a length of less than 10,000 mm, preferably less than 1,000 mm and more preferably less than 100 mm.

A development of the inventive concept proposes that at least one of the component parts and preferably all component parts be produced from felt containing a carbonaceous binder. In principle, all known binders can be used for this purpose, particularly good results being achieved with binders selected from the group consisting of phenolic resins, pitches, furan resins, phenyl esters, epoxy resins and any mixtures of two or more of the above-mentioned compounds. Felts containing such binders make for particularly suitable materials for insulation.

Furthermore, an advantageous embodiment of the present invention provides that at least one of the component parts and preferably all component parts is/are produced from felt having a heat conductivity of at most 1.5 W/(m·K) and preferably at most 0.8 W/(m·K) when measured at 2000° C. in accordance with DIN 51936. This sufficiently prevents heat conduction losses in high-temperature systems.

According to a further preferred embodiment of the present invention, at least one of the component parts and preferably all component parts of the thermal insulation body is/are produced from felt having a compressive strength measured in accordance with German industrial norm DIN EN 658-3 and/or a bending strength measured in accordance with DIN EN 658-2 and DIN 51910 of at least 0.2 MPa, preferably of at least 0.5 MPa and more preferably of at least 0.8 MPa.

Furthermore, it has proven advantageous within the context of the present invention to form the thermal insulation body as a hollow profile and preferably as a hollow cylinder. Such a hollow profile lends itself particularly well to the lining of the heating chamber of a high-temperature furnace. In this arrangement the heating chamber is protected by a hollow-profile-type thermal insulation body arranged on its internal walls from heat loss via the internal walls. High-temperature furnaces often have a cylindrical heating chamber that can be easily insulated using a suitably sized heat-insulating hollow cylinder by installing the hollow cylinder, for example, via an upper opening.

The component parts are preferably planar and form a wall of the hollow profile, each undercut being effective transversely to a surface normal of the wall. The undercut that is effective transversely to the surface normal reliably prevents the wall from “tearing apart”. More preferably, the undercut is only effective transversely to the surface normal of the wall. This opens up the possibility of bringing together or coupling the various component parts in a direction in which the undercut is ineffective, thereby simplifying assembly.

A further development of the inventive concept proposes joining at least two component parts and preferably all component parts of the thermal insulation body by means of form-fitting dovetail connections. Owing to the obtuse flanks of a dovetail, dovetail connections can give rise to a force-enhancing wedge effect, thus providing relatively high strength. In particular, they are able to transmit both transverse and tensile forces.

The aperture angle of each dovetail connection can in this case be between 5° and 85°, preferably between 15° and 75° and more preferably between 30° and 60°. Such aperture angles have proven to be particularly advantageous in terms of connection strength.

According to another embodiment of the present invention, the connection elements are designed as oblong grooves and tongues which fit therein, which grooves and tongues each have flanks that are inclined relative to one another to form the undercut. By providing inclined flanks, a “tongue and groove” connection, which is merely suitable for absorbing transverse forces, becomes a dovetail-like connection having an undercut, which absorbs both transverse and tensile forces.

A development of the inventive concept proposes that the angle between two opposite inclined flanks of a tongue or groove be between 15° and 30° and more preferably between 20° and 24°. This allows for particularly stable connections.

Furthermore, the ratio of the width of a tongue to the width of the associated component part is preferably between 1:1.5 and 1:5 and more preferably between 1:2 and 1:3. This configuration is particularly advantageous in terms of the thermal and mechanical properties of the finished thermal insulation body.

A further embodiment of the present invention provides that, viewed in the longitudinal direction, some portions of the tongues and of the grooves have no undercut and preferably do not form a press fit either. The component parts can then be brought together at a mutual offset such that the undercuts are effectively bypassed and only become effective when the component parts are shifted back in the state in which they are brought together. This makes particularly simple assembly possible since the paths that the two parts to be assembled have to cover relative to each other are considerably shorter. The omission of the undercut in some portions is particularly advantageous with the additional use of a press fit, the frictional connection of which produces an additional inhibitory effect. In this case the shorter paths also bring about less wear within the press fit.

The tongues and grooves in this arrangement preferably define regions at regular intervals which have no undercut and preferably no press fit either. For example, viewed along one component part side, regions without an undercut and preferably without a press fit either can be provided every 150 mm to 250 mm.

The thermal insulation body can define a longitudinal axis and consist of a plurality of rows of component parts arranged one behind the other along the longitudinal axis, the joining surfaces of two adjacent rows being mutually offset relative to the longitudinal axis and preferably mutually offset about a component part half-length. This produces a robust bond between the component parts similar to a brick bond involving offset bricks. In principle, hollow profiles or tubes of any given length can be constructed in this manner.

The component parts of a row are preferably assembled without forming an undercut, thereby making it easier to bring the component parts together during assembly.

For reasons of simpler production and handling and in order to increase mechanical stability, it has proven to be advantageous to round off the edges between projecting and setback portions of each connection element, the radius of curvature of the rounded edges preferably being between 1 mm and 10 mm and more preferably between 3 mm and 7 mm.

Furthermore, it is preferred for the component parts to be formed as plates, the connection elements being provided on at least two opposing narrow sides and preferably on all four narrow sides of each plate. The provision of connection elements on just two opposing narrow sides of each plate allows for particularly simply production.

According to a further preferred embodiment of the present invention, the plates are planar, the joining surfaces extending at a right angle to the planar sides of the plates. This corresponds in particular to the construction of large wall-like structures, as are often required in thermal insulation bodies.

According to an alternative embodiment of the invention, the plates are likewise planar, yet the joining surfaces extend in a plane that encloses an angle of between 1° and 85°, preferably between 30° and 75°, and more preferably between 45°, with the planar sides of the plates. In this manner, hollow profiles having a polygonal cross section for example can be constructed simply. Such hollow profiles of polygonal cross section can also be used to approximate in particular more complex curved profile structures, thereby taking advantage of the fact that planar component parts are easier to produce and more flexible to use than curved component parts.

The joining surfaces of the planar component parts can also form at least one step viewed in the direction of the surface normal. Such a stepped design of the joining surface, at which two component parts are joined, can further increase the insulating effect and strength of the thermal insulation body.

In this regard one embodiment has proven to be particularly advantageous in which the joining surfaces are divided into joining zones of equal width by the step or plurality of steps, when viewed in the direction of the surface normal in each case.

Additionally, in at least one of the joining zones of a particular joining surface there may be no connection elements provided, in which case it is preferred for the width of the joining zone or plurality of joining zones in which connection elements are provided relative to the width of the joining zone or plurality of joining zones in which connection elements are not provided to be at least 1:1 and preferably 2:1 or 3:1 viewed in the direction of the surface normal. Thus, for example, the toothed joining zone relative to the component thickness is preferably larger than the untoothed joining zone, thus ensuring sufficient stability.

The present invention also relates to a method for producing a thermal insulation body and in particular a thermal insulation body of the type described above. According to the invention at least two component parts made of a material comprising carbonized fibers and/or graphitized fibers are provided, wherein at least one connection element for form-fitting engagement to form an undercut is provided on at least two component parts to be assembled. The component parts are then assembled to form a thermal insulation body by coupling the connection elements. Coupling the component parts forms a form-fitting connection having an undercut, which reliably prevents accidental separation of the two component parts during later use of the thermal insulation body. The connection can optionally be supported using a force-locking press fit.

The connection elements are preferably produced by machining the surface of component part blanks of a homogenous felt material, preferably of a soft felt, in particular an impregnated one, or of a hard felt. Machining can take place by means of grinding, milling, sawing, drilling or cutting for example. With this approach it is not necessary to produce separate connection elements and to attach these to the component parts, thereby simplifying production of the thermal insulation body. Moreover, foreign materials are more or less automatically avoided, thus making the heat conductivity of the thermal insulation body particularly uniform.

When providing the component parts, an allowance for a press fit is preferably provided on the connection elements, which allowance is preferably at most 0.5 mm, more preferably at most 0.25 mm and most preferably between 0.01 mm and 0.2 mm. In addition to the existing form-fitting connection, the press fit provides a force-locking connection which not only increases mechanical strength but also ensures uniform heat conductivity in the region of the joining surface.

A development of the inventive concept proposes, in each joining operation, slidingly coupling two component parts in a first joining direction and then, in a second joining direction that is different from the first joining direction, moving said parts relative to each other so as to form an undercut at the connection elements which is effective in the first joining direction. This facilitates the assembly of the thermal insulation body since the component parts can be brought together without the need for excessive force.

Other features which are considered as characteristic for the invention are set forth in the appended claims.

Although the invention is illustrated and described herein as embodied in a thermal insulation body and method for the production thereof, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1A is a perspective view of a thermal insulation body according to a first embodiment of the invention;

FIG. 1B is a side view of the thermal insulation body according to FIG. 1A;

FIG. 2 is a perspective view of a thermal insulation body according to a second embodiment of the invention;

FIG. 3 is a perspective view of a thermal insulation body according to a third embodiment of the invention;

FIG. 4A is a perspective view of a component part of a thermal insulation body according to a fourth embodiment of the invention;

FIG. 4B shows a plurality of assembled component parts according to FIG. 4A;

FIG. 5A is a perspective view of a component part of a thermal insulation body according to a fifth embodiment of the invention; and

FIG. 5B shows a plurality of assembled component parts according to FIG. 5A.

### DETAILED DESCRIPTION OF THE INVENTION

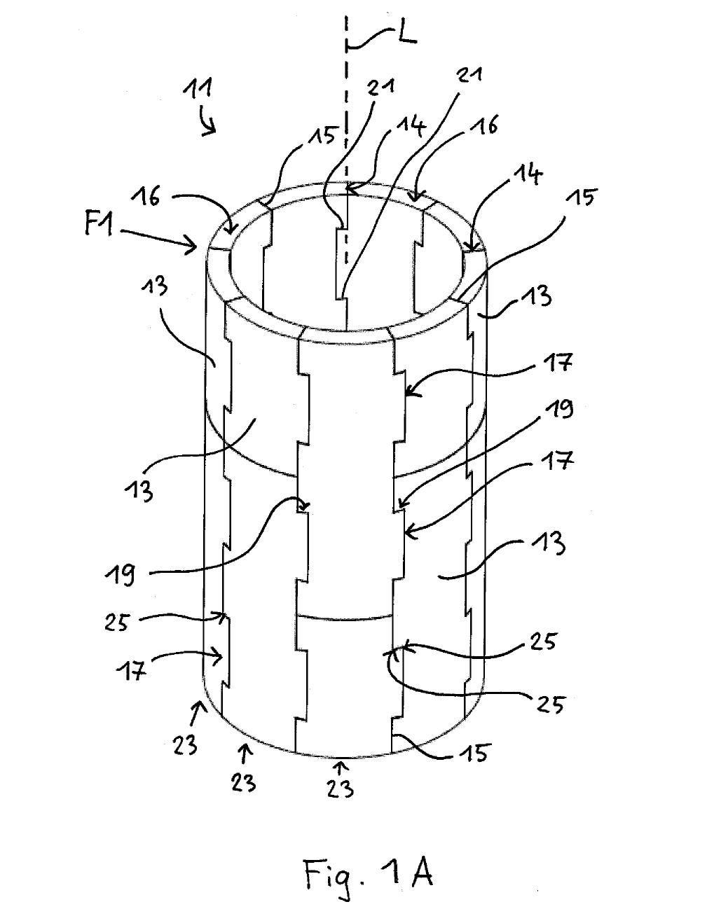

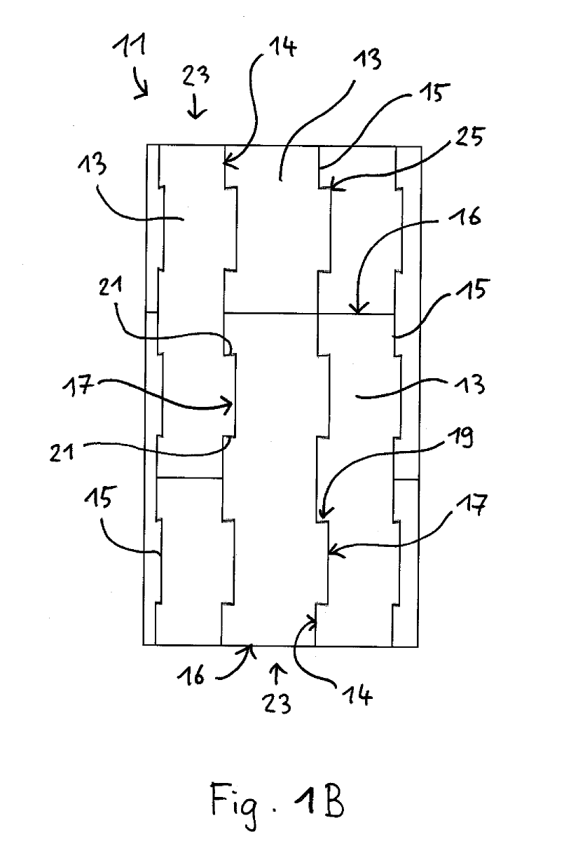

Referring now to the figures of the drawing in detail and first, particularly, to FIGS. 1A and 1B thereof, there is shown a hollow cylindrical thermal insulation body 11 having a cylinder longitudinal axis L and configured to minimize heat losses in a high-temperature system. The thermal insulation body 11 is produced from a plurality of component parts 13 each made of a hard felt based on carbonized fibers. For example, the hard felt has a thickness of 0.2 g/cm³, a compressive strength of 1 MPa, a bending strength of 1 MPa and a heat conductivity in the radial direction of 0.8 W/(m·K) at 2000° C.

The first embodiment of the invention, shown in FIGS. 1A and 1B, provides that connection elements 17 in the form of dovetail teeth are provided on the radial end faces 14 of the component parts or cylinder segments 13 and engage in a form-fitting manner to form an undercut 19. By contrast, dovetail teeth 17 are not provided on the axial end faces 16 of the cylinder segments.

To produce the dovetail teeth 17, once the felt material has been hardened and heat-treated, for example carbonized and optionally graphitized, the cylinder segments 13 are preferably machined at the relevant opposing end faces 14. The dovetail teeth 17 are thus formed directly onto the cylinder segments 13. During machining, a geometric allowance of from 0.01 mm to 0.2 mm is provided on the relevant surfaces. Following completion of the machining, the cylinder segments 13 are brought together in a joining direction F1 extending at a right angle to the cylinder longitudinal axis L, or radially, thus bringing the dovetail teeth 17 into engagement. The inclined flanks 21 of the dovetail teeth 17 form an undercut 19 which is effective in the circumferential direction and securely prevents detachment of the cylinder segments 13. Owing to the allowance provided during machining, a press fit is additionally produced which cooperates with the undercut 19. Surprisingly, it has been found that such a joint has the same heat conductivity as the rest of the felt material of the cylinder segments 13. The combination of a form-fitting and force-locking connection thus produces a particularly reliable joint, which maintains the high stability of the thermal insulation body 11 even under the high thermal and mechanical requirements in a high-temperature system. Since the joint also consists of the same material as the component itself, undesirable discontinuities in the material properties, such as heat conductivity or bending strength, are avoided. The integral formation of the cylinder segment 13 and dovetail teeth 17 also lowers production and storage costs. Moreover, the extent of the joining surfaces 15 is kept low.

The hollow cylindrical thermal insulation body 11 consists, as shown in FIGS. 1A and 1B, of a plurality of rows 23 of cylinder segments 13 arranged one behind the other along the cylinder longitudinal axis L, the joining surfaces 15 of two adjacent rows 23 being axially offset from each other by a segment half-length. In this manner, tubular thermal insulation bodies 11 of any given length can be constructed simply.

The dovetail teeth 17 preferably have an aperture angle of between 30° and 60°. Furthermore, uniform distribution of the dovetail teeth 17 onto the two relevant cylinder segments 13 has proven advantageous.

The edges 25 between projecting and setback portions of the dovetail teeth 17 are rounded off with a radius of curvature of 5 mm, although this is not visible in the representations in FIGS. 1A and 1B.

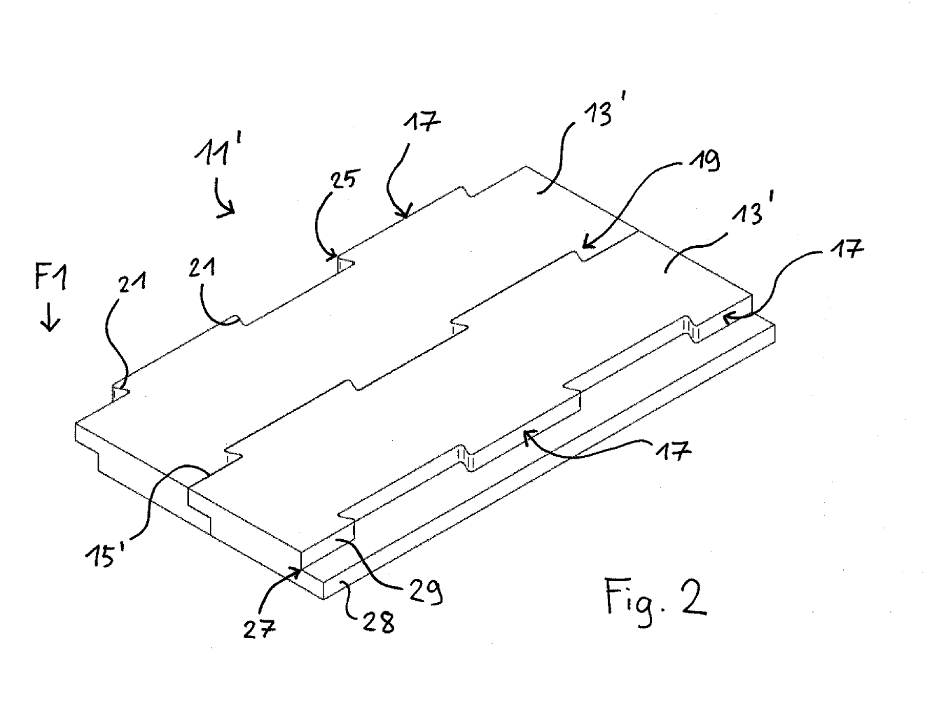

The dovetail teeth 17 described above can be used to interconnect not only cylinder segments 13 but also plate-shaped planar component parts 13′ to obtain a plate-shaped planar thermal insulation body 11′. Two planar component parts 13′ interconnected in such a manner are shown in FIG. 2. Another difference from the embodiment according to FIGS. 1A and 1B is that the joining surfaces 15′ have a stepped design, i.e. they are divided by a step 27 into two joining zones 28, 29 of equal width. In the embodiment shown in FIG. 2, dovetail teeth 17 are provided in just one of the two joining zones 28, 29. Alternatively, dovetail teeth 17 could also be provided in both joining zones 28, 29.

Should a particular application call for a more complex geometry, planar component parts 13′ according to FIG. 2 can also be combined with cylinder segments 13 according to FIGS. 1A and 1B. Furthermore, component parts of complex shape and any given curvature can also be provided and suitably combined with cylinder segments 13 or planar component parts 13′.

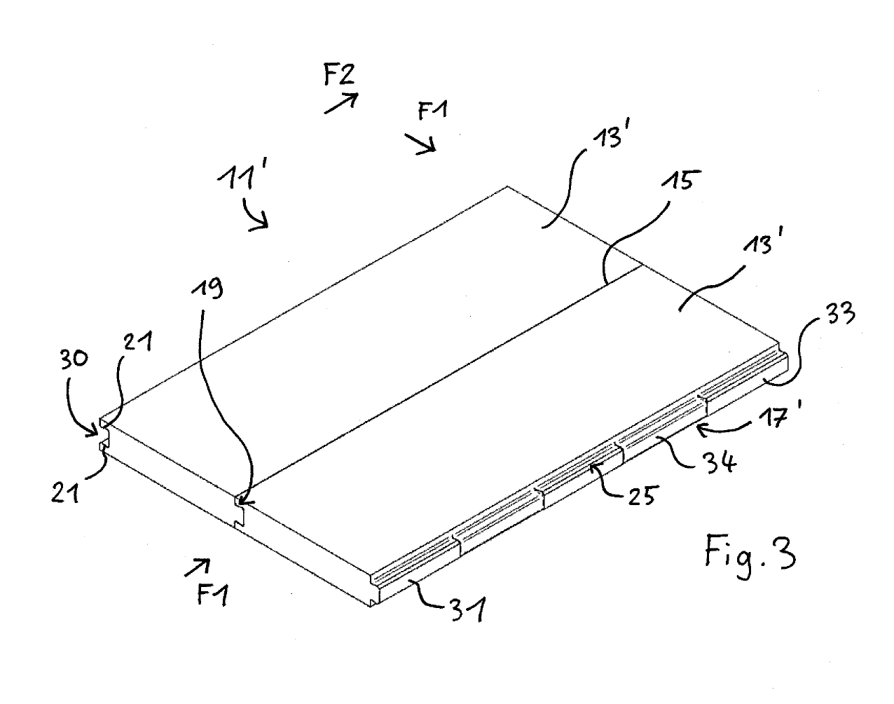

FIG. 3 shows an embodiment of the invention in which tongue-and-groove connections 17′ are provided instead of dovetail connections 17.

Specifically, oblong grooves 30, extending over the entire joining surface 15, and tongues 31 which fit therein are provided, the flanks 21 of the grooves 30 and of the tongues 31 being inclined relative to one another at an aperture angle of from 20° to 24° in each case to form an undercut 19. As in the embodiment according to FIG. 2, the thus formed undercut 19 prevents separation of the planar component parts 13′. When producing the grooves 30 and tongues 31, an allowance of from 0.01 mm to 0.2 mm is provided in each case, thus producing a press fit in the joining direction F1 when bringing together the planar component parts 13′. This is supplemented by the undercut 19 to form a robust and heat-insulating joint. The preferred ratio of the width of a tongue 31 to the thickness of the associated planar component part 13′ is between 1:2 and 1:3.

The undercut 19 is interrupted at regular intervals; that is to say, the grooves 30 and tongues 31 have alternating regions 33 with an undercut and regions 34 without an undercut. During assembly, two component parts 13′ can therefore be arranged at a mutual offset such that two regions 34 without an undercut meet. In this arrangement, the component parts 13′ can be slid together in a first joining direction F1, the joining surfaces 15 initially loosely abutting each other. By then moving the component parts 13′ in parallel along a second joining direction F2 that extends at a right angle to the first joining direction F1, the undercut 19 come into engagement, thus again producing a combination of a form-fitting and force-locking connection between the relevant component parts 13′.

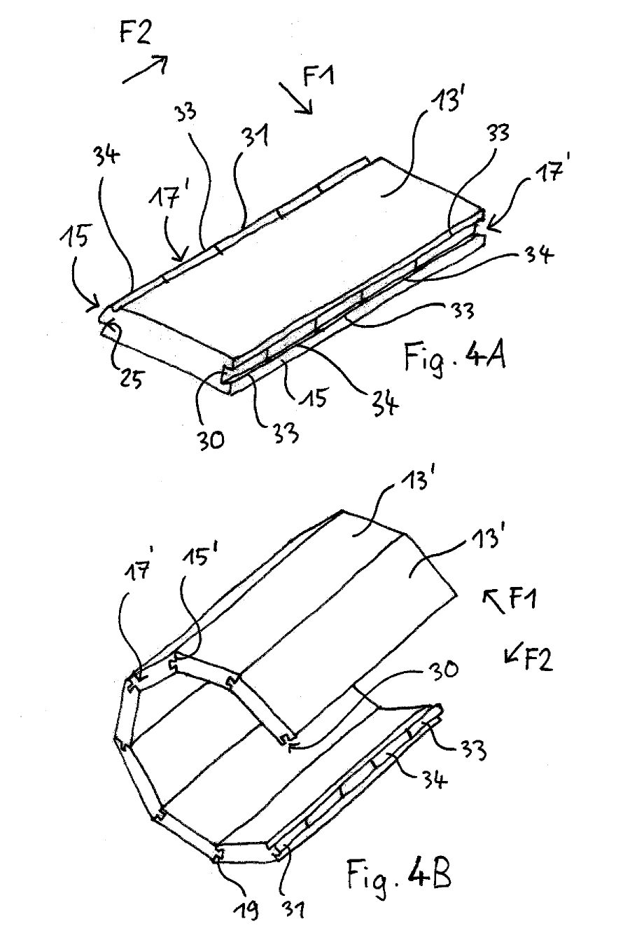

In the further embodiment of the invention shown in FIGS. 4A and 4B, oblong grooves 30 and associated tongues 31 are provided on opposite end faces of the various planar component parts 13′, as in the embodiment according to FIG. 3. Here too the undercut 19 is interrupted at regular intervals; that is to say, the grooves 30 and the tongues 31 have alternating regions 33 with an undercut and regions 34 without an undercut.

As can be seen in FIG. 4A, the joining surfaces 15 in which a groove 30 is formed extend in a plane at right angles to the plate plane. However, the joining surfaces 15 having a tongue 31 enclose an angle of between 1° and 85° with the plate plane. In this manner, hollow profiles can be easily constructed from planar component parts 13′, as illustrated in FIG. 4B. When producing closed profiles such as tubes and cylinders in this manner, an even number of component parts 13′ has proven advantageous. In this manner, on the one hand a symmetrical extension of uniform mechanical load-bearing capacity is possible, and on the other hand two half-shells can also initially be constructed from individual elements, which half-shells are interconnected in a final joining process by movement along a plane.

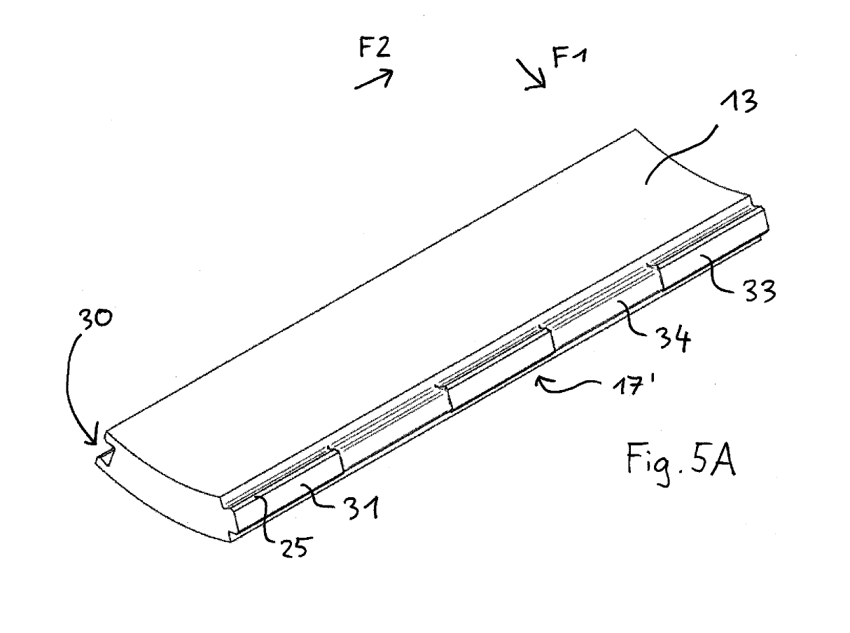

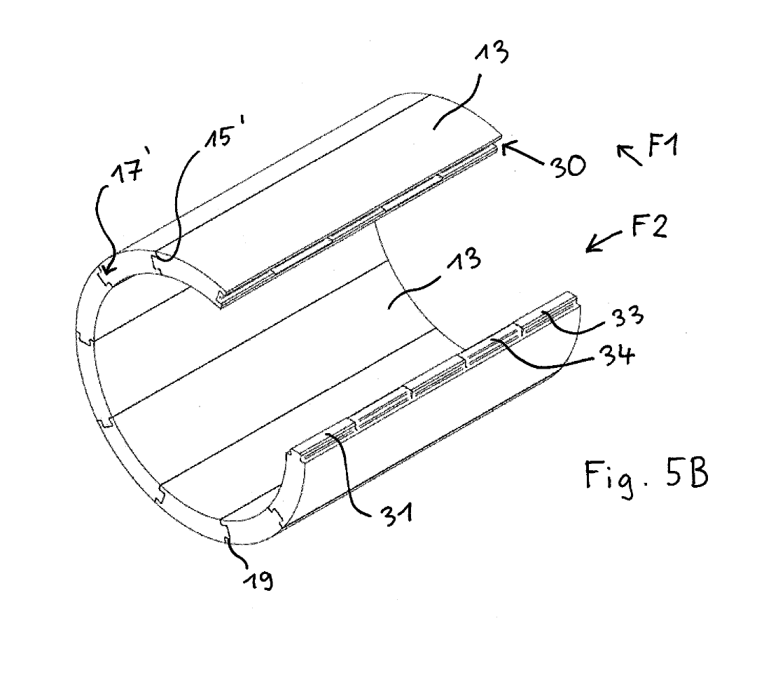

In the further embodiment of the present invention shown in FIGS. 5A and 5B, oblong grooves 30 and associated tongues 31 are provided on opposite end faces of the various planar component parts 13′, as in the embodiment according to FIGS. 3, 4A and 4B. Once again, the undercut 19 is interrupted at regular intervals; that is to say, the grooves 30 and the tongues 31 have alternating regions 33 with an undercut and regions 34 without an undercut. The component parts 13 in this embodiment have, however, a cylindrical curvature which allows a plurality of component parts 13 to be assembled to form a hollow cylindrical component, as shown in FIG. 5B.

The following is a summary list of reference numerals and the corresponding structure used in the above description of the invention:
11, 11′ Thermal insulation body
13, 13′ Component part/cylinder segment
14 Radial end face
15, 15′ Joining surface
16 Axial end face
17, 17′ Connection element
19 Undercut
21 Flank
23 Row
25 Edge
27 Step
28 First joining zone
29 Second joining zone
30 Groove
31 Tongue
33 Region with an undercut
34 Region without an undercut
L Cylinder longitudinal axis
F1 First joining direction
F2 Second joining direction

1. A thermal insulation body, comprising:
an assembly of at least two component parts made of a material having carbonized fibers and/or graphitized fibers;
at least two said assembled component parts each having at least one connection element and said connection elements of said at least two assembled component parts engaging one another with a form-fitting connection forming an undercut.

2. The thermal insulation body according to claim 1, wherein said connection elements of said at least two assembled component parts additionally engage one another with a force lock to form a press fit.

3. The thermal insulation body according to claim 1, wherein said connection elements of said at least two component parts are formed directly onto said component parts.

4. The thermal insulation body according to claim 1, wherein at least one of said component parts, including said connection element, is produced from a homogenous felt composed of carbonized fibers and/or graphitized fibers.

5. The thermal insulation body according to claim 4, wherein all of said component parts and said connection elements are produced from said homogenous felt composed of carbonized fibers and/or graphitized fibers.

6. The thermal insulation body according to claim 4, wherein said component parts, including said connection elements, are produced from the same material.

7. The thermal insulation body according to claim 6, wherein said component parts and said connection elements are produced from a soft felt, optionally impregnated, composed of carbonized fibers and/or graphitized fibers, or from a hard felt composed of carbonized fibers and/or graphitized fibers.

8. The thermal insulation body according to claim 1, wherein said assembly forming the thermal insulation body is formed as a hollow profile.

9. The thermal insulation body according to claim 8, wherein said hollow profile is a hollow cylinder.

10. The thermal insulation body according to claim 8, wherein said component parts are planar and form a wall of said hollow profile, each undercut being effective transversely to a surface normal of said wall.

11. The thermal insulation body according to claim 1, wherein said at least two said component parts are assembled and connected by way of dovetail connections.

12. The thermal insulation body according to claim 1, wherein said connection elements are oblong grooves and tongues fitting into said grooves, and said grooves and tongues are each formed with flanks that are inclined relative to one another to form said undercut.

13. The thermal insulation body according to claim 11, wherein, viewed in the longitudinal direction, some portions of said grooves and of said tongues do not form an undercut.

14. The thermal insulation body according to claim 13, wherein some portions of said grooves and of said tongues also do not form a press fit.

15. The thermal insulation body according to claim 1, wherein said component parts are plates and said connection elements are provided on at least two opposing narrow sides of said plates or on all four narrow sides of each plate.

16. The thermal insulation body according to claim 13, wherein joining surfaces of said plates form at least one step viewed in a direction of the surface normal.

17. A method of producing a thermal insulation body, the method comprising the following steps:
providing at least two component parts, made of a material including carbonized fibers and/or graphitized fibers, with at least one connection element for form-fitting engagement to form an undercut on at least two assembled component parts; and
assembling the component parts to form a thermal insulation body by coupling the connection elements to one another.

18. The method according to claim 17, which comprises producing the connection elements by machining a surface of component part blanks of a homogenous felt material.

19. The method according to claim 18, wherein the felt material is a soft felt, optionally impregnated, or a hard felt.

20. The method according to claim 17, which comprises providing the component parts with an allowance for a press fit on the connection elements, and selecting the allowance from the group consisting of at most 0.5 mm, at most 0.25 mm, and between 0.01 mm and 0.2 mm.
